(19) United States
(12) Patent Application Publication
(10) Pub. No.: US 2013/0112488 A1
(43) Pub. Date: May 9, 2013

(54) WEIGHING SCALES

(71) Applicants: Lukas Mayerhofer, Babensham (DE); Hans Schäfer, Munchen (DE)

(72) Inventors: Lukas Mayerhofer, Babensham (DE); Hans Schäfer, Munchen (DE)

(73) Assignee: BSH BOSCH UND SIEMENS HAUSGERÄTE GMBH, Munich (DE)

(21) Appl. No.: 13/809,169

(22) PCT Filed: Jul. 12, 2011
(86) PCT No.: PCT/EP2011/061820

§ 371 Date: Jan. 9, 2013

(30) Foreign Application Priority Data
Jul. 28, 2010 (DE) 10 2010 038 581.6

(51) Int. Cl. G01G 19/44

(52) U.S. Cl. CPC G01G 19/44
USPC 177/177

(57) ABSTRACT

A weighing scales includes a step-on surface, on which a person to be weighed stands, and a plurality of artificial gemstones arranged beneath or in the step-on surface. At least some of the artificial gemstones are adapted for illumination from below so as to produce information, such as a weight indication, which is readable visually from above.

The present invention relates to weighing scales having a step-on surface on which the person to be weighed stands.

Weighing scales and in particular in recent times weighing scales with measuring electrodes for measuring body-specific properties, for example a body fat ratio, muscle ratio or bone mass, have become increasingly widely used as a result of increasing body awareness. As well as their correction operation, the design of such weighing scales is increasingly important in particular in modem bathrooms. Glitter effects are particularly popular, being produced for example using ground glass or ground crystal.

The present invention deals with the problem of specifying an improved embodiment for weighing scales of the generic type, which is characterized in particular by a novel and visually pleasing display.

According to the invention this problem is resolved by the subject matter of the independent claim 1. Advantageous embodiments are the subject matter of the dependent claims.

The present invention is based on the general concept of arranging a plurality of artificial gemstones beneath or in a step-on surface, on which a person to be weighed generally stands to be weighed, with known weighing scales, it being possible to illuminate at least some of said artificial gemstones from below so that they produce information that can be read visually from above, in particular a weight indication. Compared with a hitherto known segment display, such a display of illuminated and sparkling artificial gemstones produces a visually extremely pleasing appearance and in particular the display can also be read easily in the dark, which generally was not possible with previous segment displays. The artificial gemstones integrated in the weighing scales do not however serve solely to indicate weight but can, depending on the configuration of the weighing scales, indicate additional information, such as a body-fat ratio, muscle ratio or bone mass of the person being weighed. The inventive arrangement of the artificial gemstones beneath or within the step-on surface allows the novel and pleasing display to be achieved, without the inventive weighing scales feeling haptically different from conventional weighing scales.

In one advantageous development of the inventive solution a screen is provided, which allows the isolated illumination of at least one artificial gemstone. Such a screen has the purpose in particular of preventing scattered light and therefore unwanted lighting of surrounding artificial gemstones, it also being possible for the screen to have cutouts or cavities, in which the artificial gemstones are embedded. This has the advantage that the artificial gemstones then only have to be inserted, allowing an expensive bonding operation to be avoided. Generally however it is of course also possible to bond the artificial gemstones to the screen, with a transparent glass surface then being arranged above the screen or above the artificial gemstones, which at the same time forms the step-on surface. By embodying the screen as colored and/or predefining the light permeability of the screen, it is also possible to influence the visually output display. The step-on surface, which is configured from glass, also prevents soiling of the screen and the artificial gemstones arranged therein/thereon, allowing the visual effect, in other words the glitter and sparkle, to be maintained for a long time. A light source, for example a light-emitting diode, is preferably assigned to each screen here, although it is of course also possible for a single light source to be connected to different screens by way of individual light conductors.

A number of light-emitting diodes are expediently provided to illuminate the artificial gemstones. Such light-emitting diodes are electronic semiconductor components, which convert a majority of the electrical energy to light and are therefore very different from conventional incandescent lamps. With conventional incandescent lamps a large proportion of the electrical energy is converted to heat and is therefore lost as far as light output is concerned. LEDs also have a much longer service life than conventional incandescent lamps and can be manufactured in a very wide range of colors, again allowing individual and attractive light effects to be achieved.

Further important features and advantages of the invention will emerge from the subclaims, the drawings and the associated description of the figures with reference to the drawings.

It is evident that the features cited above and below can be used not only in the respectively specified combination but also in other combinations or alone, without departing from the scope of the present invention.

Preferred exemplary embodiments of the invention are illustrated in the drawings and will be explained in greater detail in the description which follows, with identical reference characters relating to identical or similar or functionally identical components.

In the schematic drawings:

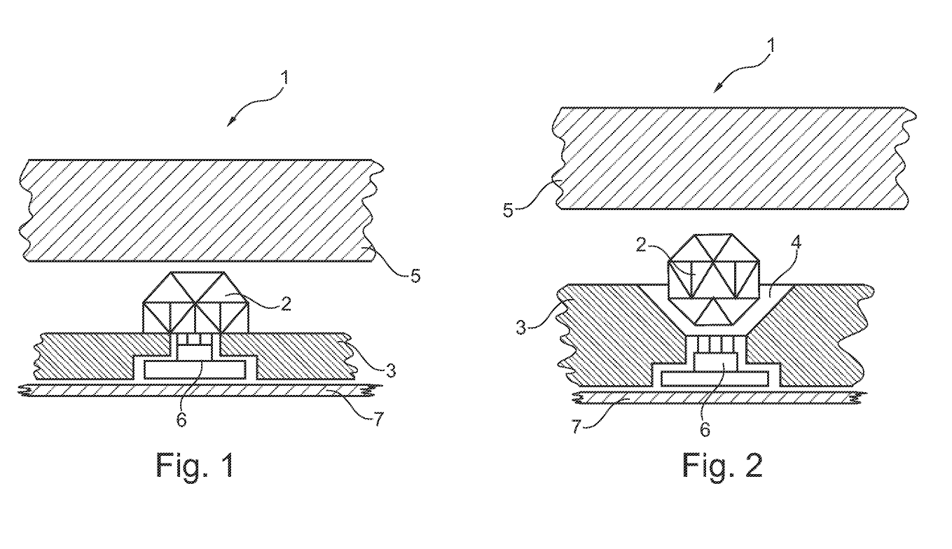

FIG. 1 shows a sectional view through inventive weighing scales in the region of a artificial gemstone;

FIG. 2 shows a diagram as in FIG. 1 but for a different embodiment.

According to FIGS. 1 and 2 inventive weighing scales 1 have a step-on surface, on which the person to be weighed can stand. Arranged beneath or within said step-on surface are a plurality of artificial gemstones 2, for example rhinestones, crystals and/or ground glass pieces, it being possible to illuminate at least some of said artificial gemstones 2 from below in such a manner that they produce information that can be read visually from above, in particular a weight indication. A screen 3 is also provided, which allows isolated illumination of at least one artificial gemstone 2 and in particular prevents scattered light effects and therefore unwanted lighting of surrounding artificial gemstones 2. The screen 3 here can have a cutout 4, as shown in FIG. 2, in which at least part of the artificial gemstone 2 is held. It is also possible here for the artificial gemstone 2 in this instance to be configured in such a manner that it can be arranged in the cutout 4 in the screen 3 in such a manner that it is arranged flush with the surface of the screen 3. The top face of the screen 3 would then also form the step-on surface. Alternatively a transparent glass plate 5 can be arranged above the screen 3 to form the actual step-on surface and at the same time to protect the artificial gemstones 2 arranged beneath it from damage and/or soiling.

Provided to illuminate the individual artificial gemstones 2 are a number of light sources, which are configured in particular as light-emitting diodes 6. Such light-emitting diodes 6 have the major advantage of requiring relatively little energy, as they convert energy mainly to light and not to heat like previous incandescent lamps. Such light-emitting diodes 6 can also be manufactured in almost any color and can therefore produce individually colored light. Such light-emitting diodes 6 also have the particular advantage that they have a much longer service life than conventional incandescent lamps. The light-emitting diodes 6 here can be configured for example as SMD-LEDs (surface mounted light-emitting diodes) so they have a comparatively small height. Such SMD light-emitting diodes 6 are soldered to a circuit board 7 arranged beneath the screen 3 for the supply of power.

If we look now at the two structural forms according to FIGS. 1 and 2, it can be seen that the artificial gemstone 2 according to FIG. 1 is arranged above, in particular bonded to a surface of the screen 3. In contrast the artificial gemstone 2 in weighing scales 1 according to FIG. 2 is inserted into the cutout 4 and bonded or caulked in place there. It is also generally possible simply to insert the artificial gemstone 2 into the cutout 4.

It is of course also possible for at least some artificial gemstones 2 preferably to be illuminated from below, simply to produce designer effects, in particular to produce glitter/shine effects.

In principle the inventive weighing scales 1 can be configured not only to capture weight but also to capture body-specific properties, such as a body-fat ratio, muscle ratio or bone mass, thereby exhibiting a high level of functionality. The determined body-specific properties can also be indicated by way of the individually illuminated artificial gemstones 2 in a particularly visually attractive manner. The inventive weighing scales 1 therefore allow a totally novel display of an indication, which also satisfies the most stringent aesthetic requirements.

### LIST OF REFERENCE CHARACTERS

1 Weighing scales
2 Artificial gemstone
3 Screen
4 Cutout
5 Glass plate
6 Light-emitting diode
7 Circuit board

1-10. (canceled)

11. A weighing scales, comprising:
a step-on surface, on which a person to be weighed stands; and
a plurality of artificial gemstones arranged beneath or in the step-on surface, at least some of the artificial gemstones being adapted for illumination from below so as to produce information which is readable visually from above.

12. The weighing scales of claim 11, wherein the information is a weight indication.

13. The weighing scales of claim 11, wherein the artificial gemstones are selected from the group consisting of rhinestones, crystals and ground glass pieces.

14. The weighing scales of claim 11, further comprising a screen to allow isolated illumination of at least one of the artificial gemstones.

15. The weighing scales of claim 14, wherein the screen has at least one cutout to hold the at least one of the artificial gemstones.

16. The weighing scales of claim 14, wherein the screen has a top face which forms the step-on surface, with the artificial gemstones being let into the screen so that their surfaces are flush.

17. The weighing scales of claim 14, further comprising a transparent glass plate arranged above the screen and forming the step-on surface.

18. The weighing scales of claim 11, further comprising a number of light-emitting diodes to illuminate the artificial gemstones.

19. The weighing scales of claim 18, wherein at least one of the light-emitting diodes is configured as an SMD-LED (surface mounted light-emitting diode).

20. The weighing scales of claim 18, further comprising a circuit board and a screen resting on the circuit board and allowing isolated illumination of at least one of the artificial gemstones, said light-emitting diodes being fastened to the circuit board and enclosed by the screen.

21. The weighing scales of claim 11, configured to capture a body-specific property selected from the group consisting of body-fat ratio, muscle ratio and bone mass.

22. The weighing scales of claim 11, wherein at least some artificial gemstones are illuminated from below to produce a designer effect.
